(19) United States
(12) Patent Application Publication
(10) Pub. No.: US 2017/0363192 A1
(43) Pub. Date: Dec. 21, 2017

(54) HYDRAULIC DEVICE WITH SLEEVE INSERT

(71) Applicant: EATON CORPORATION, Cleveland, OH (US)

(72) Inventors: Jay Paul LUCAS, Plymouth, MN (US); Trimbak Shridhar ATTARDE, Pimple Gurav, Pune (IN); Hrishikesh Narayan THAKUR, Kharadi, Pune (IN); Vivek Babulal HIRE, Kharadi, Pune (IN)

(21) Appl. No.: 15/527,669

(22) PCT Filed: Nov. 16, 2015
(86) PCT No.: PCT/US2015/060845

§ 371 Date: May 17, 2017

Related U.S. Application Data
(60) Provisional application No. 62/080,790, filed on Nov. 17, 2014.

(51) Int. Cl. F16H 45/00; F16D 55/30; F16D 55/32; F03C 2/08; B60K 17/10; B60K 17/04

(52) U.S. Cl. CPC F16H 45/00; F16D 55/30; F16D 55/32; B60K 17/10; B60K 17/043; F03C 2/08

(57) ABSTRACT

A hydraulic device is provided with a sleeve insert disposed between a driven hub and a stationary housing. The hydraulic device further includes a hydraulic motor to actuate the driven hub through a drive shaft and a coupling mechanism. A sealing element is disposed between the sleeve insert and the stationary housing. The sleeve insert is fixed to the driven hub and disposed between the stationary housing and the driven hub to provide a riding surface on which the sealing element slides as the driven hub rotates relative to the stationary housing.

### CROSS-REFERENCE TO RELATED APPLICATION

This application is being filed on Nov. 16, 2015 as a PCT International Patent Application and claims the benefit of U.S. Patent Application Ser. No. 62/080,790, filed on Nov. 17, 2014, the disclosure of which is incorporated herein by reference in its entirety.

### BACKGROUND

Hydraulic devices that are used in a variety of applications, such as propel-vehicle applications, can include hydraulic motors and brake packages. In certain examples, brake packages can be used as integral brake packages with low-speed, high-torque gerotor motors. Such hydraulic devices include a stationary housing and a rotating housing configured to rotate relative to the stationary housing when driven by an associated hydraulic motor. In some configurations, the stationary housing and the rotating housing cooperate to define an interior brake fluid chamber to actuate an associated brake mechanism.

### SUMMARY

The present disclosure is directed to a hydraulic device with a sleeve insert disposed between a driven hub and a stationary housing.

In one aspect, the hydraulic device may include a stationary housing and a driven hub configured to rotate relative to the stationary housing. The hydraulic device may include a hydraulic motor to actuate the driven hub through a drive shaft. The stationary housing and the driven hub defines a brake fluid chamber to actuate a brake mechanism for the driven hub. The brake fluid chamber may be sealed by a sealing element disposed at an interface between the stationary housing and the driven hub. As the driven hub rotates relative to the stationary housing, the interface between the driven hub and the stationary housing can be subjected to wear, resulting in replacement of at least one of the driven hub and the stationary housing. Further, for appropriate sealing, the driven hub and the stationary housing do not allow a large clearance at the interface thereof Such a small clearance can make it difficult to assemble the driven hub with the stationary housing without damage to the interface between the driven hub and the stationary housing.

To minimize the wear of the driven hub and/or the stationary housing, the hydraulic device includes a sleeve insert disposed at the interface between the driven hub and the stationary housing. A sealing element may be disposed between the sleeve insert and the stationary housing. The sleeve insert is disposed between the stationary housing and the driven hub to provide a riding surface on which the sealing element slides as the driven hub rotates relative to the stationary housing. Because the sleeve insert is made as a separate piece from the driven hub, the driven hub can be made of a less wear-resistant material, thereby reducing manufacturing costs of the hydraulic device.

Further, the configuration of the driven hub with the separate sleeve insert can ease assembly of the driven hub to the stationary housing. This can allow for an increased clearance between the stationary housing and the driven hub during the installation. In certain examples, the driven hub is first installed over the stationary housing without the sleeve insert. Then, the sleeve insert is disposed between the driven hub and the stationary housing to provide a riding surface for the sealing element arranged between the driven hub and the stationary housing as the driven hub rotates relative to the stationary housing. This configuration can thereby reduce assembly costs and minimize a risk of damage to a seal surface for the sealing element during the installation.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is an isometric view of an example hydraulic device having exemplary features in accordance with the principles of the present disclosure.

FIG. 2 is an exploded isometric view of exemplary components of the hydraulic device of FIG. 1.

FIG. 3 is an exploded isometric view of exemplary components of FIG. 2 including a brake assembly and a sleeve insert suitable for use in the hydraulic device of FIG. 1.

FIG. 4 is a cross-sectional view of the hydraulic device of FIG. 1.

FIG. 5 is an isometric cross-sectional view of the hydraulic device of FIG. 1 illustrating the sleeve insert and associated components of the hydraulic device.

FIG. 6 is an isometric view of an exemplary sleeve insert.

FIG. 7 is a flowchart illustrating an example of assembling the hydraulic device of FIG. 1.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

Examples of the disclosure described above may be particularly useful in propel vehicle applications, such as compact track loaders, sprayers, combines or other low speed, high torque vehicles. One or more hydraulic devices may be coupled to a track, a wheel or a sprocket/gear driving a track. Hydraulic devices in accordance with the principles of the present disclosure can also be used to drive chipping/grinding drums, chipping/grinding wheels or discs, drill heads, or other rotatable structures.

Generally disclosed is a hydraulic device. The hydraulic device may include a stationary housing and a driven hub configured to rotate relative to the stationary housing. A hydraulic motor is provided to actuate the driven hub through a drive shaft and a coupling mechanism. The hydraulic device includes a sleeve insert disposed between the driven hub and the stationary housing. A sealing element is disposed between the sleeve insert and the stationary housing. The sleeve insert is fixed to the driven hub and disposed between the stationary housing and the driven hub to provide a riding surface on which the sealing element slides as the driven hub rotates relative to the stationary housing. The sleeve insert, as a separate piece from the driven hub, can allow the driven hub to be made of a less wear-resistant material, thereby reducing manufacturing costs of the hydraulic device. Further, the configuration of the driven hub with the separate sleeve insert can ease assembly of the driven hub to the stationary housing. This configuration can allow for an increased clearance between the stationary housing and the driven hub during the installation, thereby reducing assembly costs and minimizing a risk of damage to a seal surface for the sealing element during the installation.

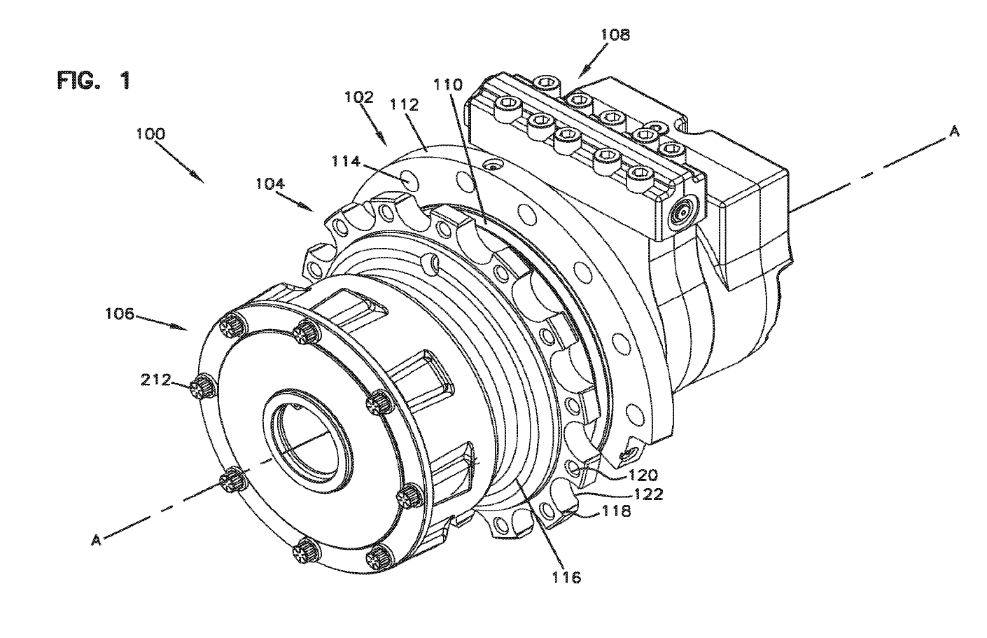

Referring to FIGS. 1-9, a hydraulic device 100 is disclosed in accordance with the principles of the present disclosure. In some examples, the hydraulic device 100 is configured as a combined hydraulic motor and brake assembly. In this document, therefore, the hydraulic device 100 can also be referred to as the combined hydraulic motor and brake assembly. The hydraulic device 100 may include a stationary housing 102, a driven hub 104, a coupling mechanism 106, and a hydraulic motor 108.

The stationary housing 102 is configured to couple the hydraulic device 100 to a non-driven and stationary element such as a portion of a vehicle frame. The stationary housing 102 can also be referred to as an inner housing. The stationary housing 102 includes a main body 110 and a mounting flange 112 projecting radially outwardly from the main body 110. The mounting flange 112 defines a plurality of first fastener openings 114 for receiving first fasteners (e.g., bolts not shown) used to secure the stationary housing 102 to the non-driven and stationary element. The mounting flange 112 is generally semi-circular in shape, but other shapes could be used as well (e.g., full rings or other shapes). In other examples, the hydraulic device 100 may include other mounting assemblies for coupling the hydraulic device 100 to a non-driven and stationary element.

The driven hub 104 is configured to couple the hydraulic device 100 to a driven and non-stationary element such as a wheel, sprocket or other structure intended to be rotated. The driven hub 104 can also be referred to as an outer housing or a rotating housing. The driven hub 104 may be mounted at least partially over the stationary housing 102. The driven hub 104 includes a main body 116 and a plurality of tabs 118 that project radially outwardly from the main body 116. The tabs 118 are circumferentially spaced around a perimeter of the main body 116 of the driven hub 104. The driven hub 104 includes a plurality of second fastener openings 120 for receiving second fasteners (e.g., bolts not shown) used to secure the driven hub 104 to a driven element. The second fastener openings 120 may be defined through the tabs 118. The tabs 118 are separated by pockets 122. At least some of the pockets 122 may align with the first fastener openings 114 to facilitate accessing the first fastener openings 114, for example during the installation of the hydraulic device 100. In other examples, configurations other than tabs (e.g., solid flanges or other structures) can be used to connect the driven hub to a driven element. In yet other examples, the hydraulic device 100 may include other mounting assembles for coupling the hydraulic device 100 to a driven and non-stationary element.

The coupling mechanism 106 operates to couple the drive shaft 130 to the driven hub 104 such that torque from the drive shaft 130 is transferred to the driven hub 104 causing the driven hub 104 to rotate relative to the stationary housing 102. An example of the coupling mechanism 106 is illustrated and described herein in more detail.

The hydraulic motor 108 operates to rotate the drive shaft 130 relative to the stationary housing 102. An example of the hydraulic motor 108 is illustrated and described herein in more detail.

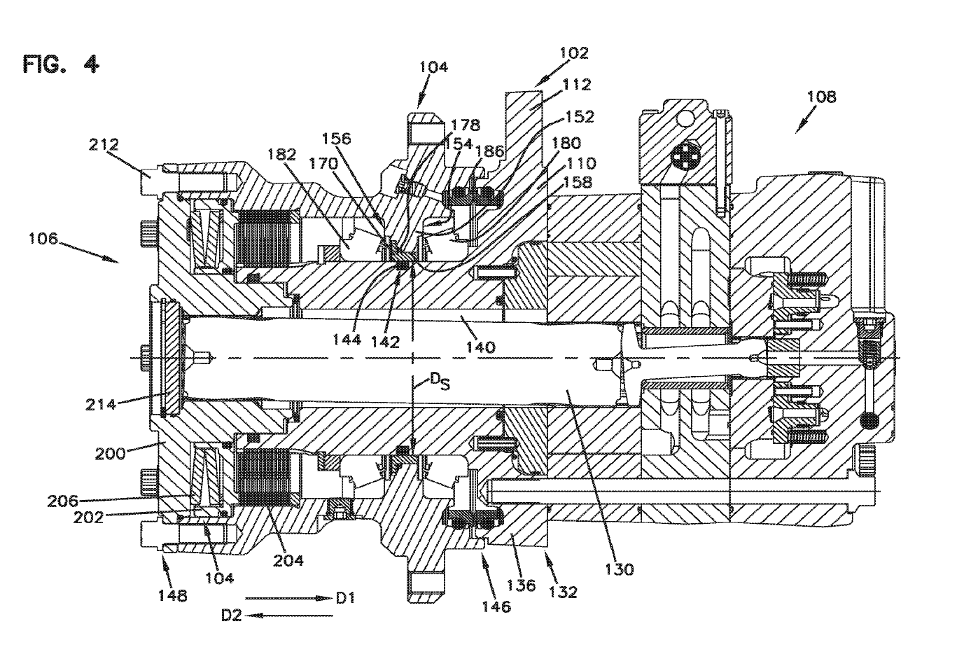

Referring to FIG. 4, a cross-sectional view of the hydraulic device 100 is illustrated. As described above, the hydraulic device 100 includes the stationary housing 102, the driven hub 104, the coupling mechanism 106, and the hydraulic motor 108. In addition, the hydraulic device 100 includes a main drive shaft 130, a sleeve insert 170, and bearings 180 and 182.

As described above, the stationary housing 102 includes the main body 110. The main body 110 has a first housing end 132 and a second housing end 134 opposite to the first housing end 132 along an axis of rotation A. The main body 110 may include a base portion 136 and a shaft portion 138. The base portion 136 is arranged at the first housing end 132. The shaft portion 138 projects from the base portion 136 and extends between the first and second housing ends 132 and 134. The shaft portion 138 defines a shaft passage 140 through which the main drive shaft 130 extends.

The stationary housing 102 may include a sealing groove 142 radially formed around the outer circumference of the shaft portion 138. As described herein, the sealing groove 142 is adapted to receive a sealing element 144 such that the sealing element 144 (e.g., an annular gasket such as an elastomeric O-ring) is disposed between the stationary housing 102 and the driven hub 104.

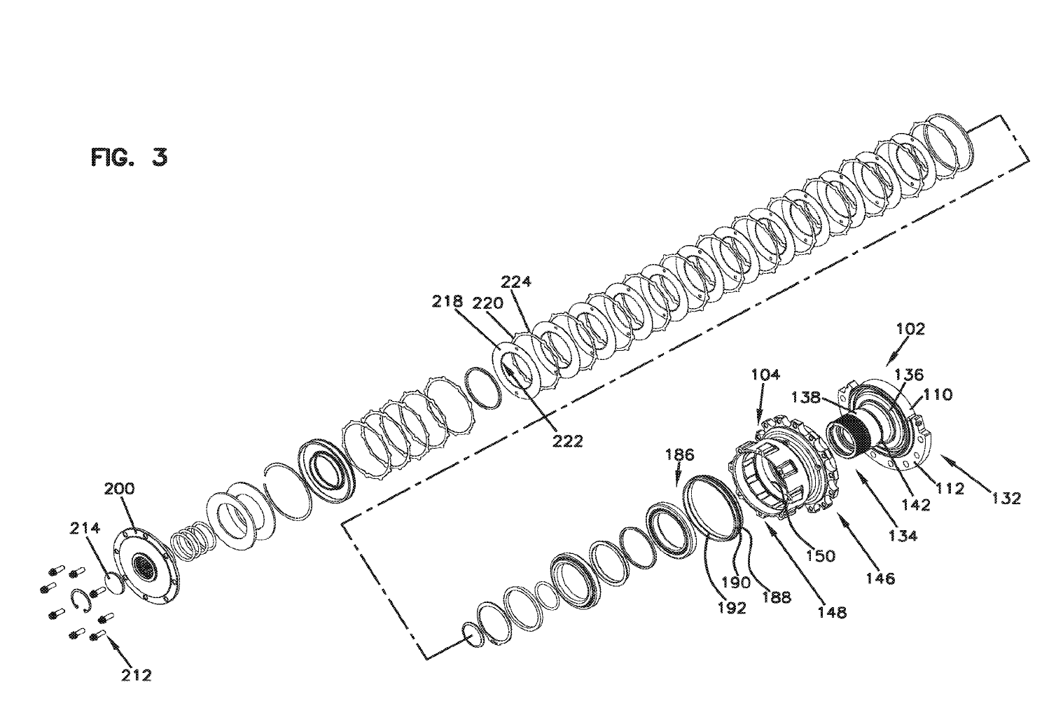

The driven hub 104 includes a first hub end 146 and a second hub end 148 opposite to the first hub end 146 along the axis of rotation A. The driven hub 104 defines an inner bore 150 (FIG. 3) that generally extends between the first and second hub ends 146 and 148.

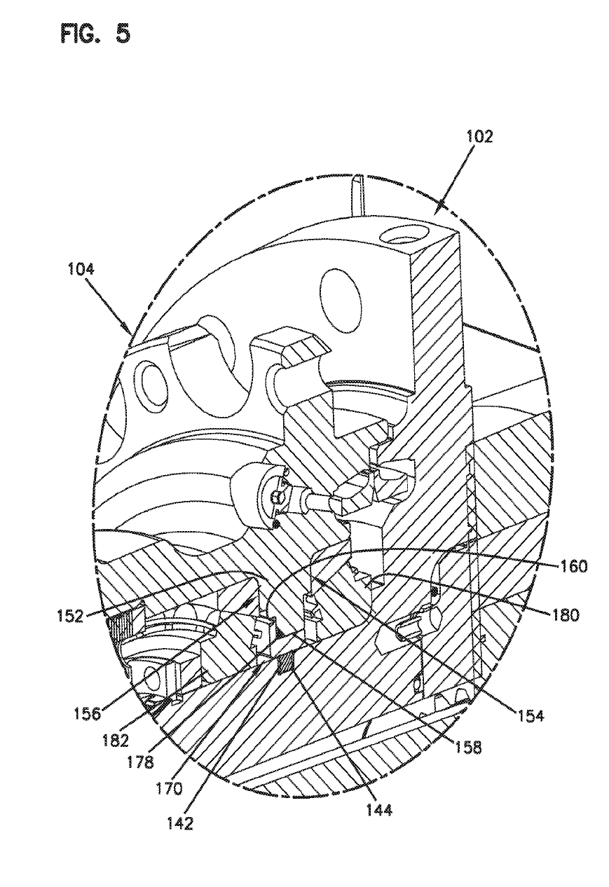

The driven hub 104 includes an inner wall 152 radially inwardly extending from an inner surface of the driven hub 104. The inner wall 152 has a first axial face 154 and a second axial face 156 opposite to the first axial face 154. The first axial face 154 is arranged toward the first hub end 146, and the second axial face 156 is arranged toward the second hub end 148. When the driven hub 104 is assembled with the stationary housing 102, the first axial face 154 is arranged to face the first housing end 132 and the second axial face 156 is arranged to face the second housing end 134. In some examples, as shown in FIGS. 4 and 5, the first and second axial faces 154 and 156 can at least partially include one or more recessed portions such that a width of the inner wall 152 (i.e., a distance between the first and second axial faces 154 and 156) along the axis of rotation A at the recessed portions is smaller than other portions of the inner wall 152. In the depicted example, the first and second axial faces 154 and 156 have recessed portions, respectively, which are symmetrically positioned relative to a center axis of the inner wall 152 perpendicular to the axis of rotation A. The recessed portions of the first and second axial faces 154 and 156 do not contact the bearings 180 and 182 while the other portions of the faces 154 and 156 contact the bearings 180 and 182. In other examples, such recessed portions can have different shapes and arrangements. For example, only one of the first and second axial faces 154 and 156 can have a recessed portion.

The inner wall 152 further has a radial end 158 connecting the first and second axial faces 154 and 156. The radial end 158 of the inner wall 152 defines an opening through which the shaft portion 138 of the stationary housing 102 passes, and thus generally faces the outer surface of the shaft portion 138 of the stationary housing 102 when the driven hub 104 is assembled with the stationary housing 102.

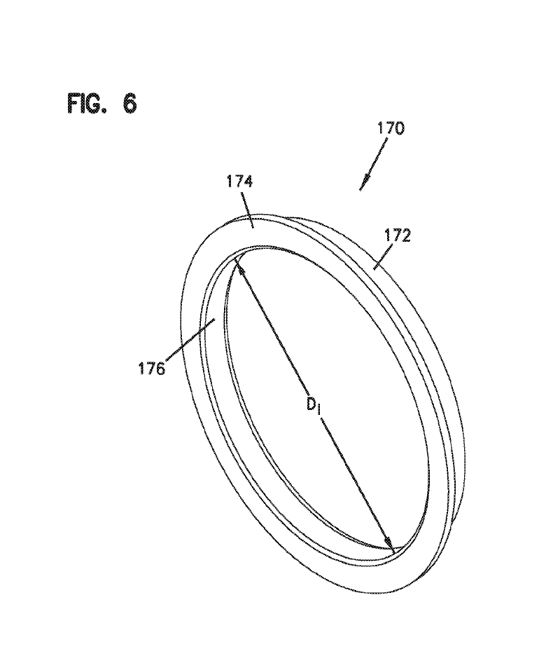

The inner wall 152 of the driven hub 104 is configured to mount the sleeve insert 170 thereon such that the sleeve insert 170 is disposed between the radial end 158 of the inner wall 152 and the sealing groove 142 of the stationary housing 102. As described herein, the sleeve insert 170 provides a riding surface 176 (FIG. 6) on which the sealing element 144 disposed in the sealing groove 142 slides as the driven hub 104 rotates relative to the stationary housing 102.

In some examples, the inner wall 152 includes a recess 160 formed on the second axial face 156 at the radial end 158. The recess 160 reduces a width of the inner wall 152 at or around the radial end 158. The recess 160 is configured to receive a flange portion 174 (FIG. 5) of the sleeve insert 170 and operate as a positive stop that limits inward axial movement of the sleeve insert 170 relative to the inner wall 152. For example, when the sleeve insert 170 is fitted to the inner wall 152 at the radial end 158, the recess 160 limit the insertion of the sleeve insert 170 to the inner wall 152 by engaging the flange portion 174 of the sleeve insert 170 therewith.

Referring to FIGS. 4 and 5, the sleeve insert 170 is mounted on the radial end 158 of the inner wall 152 to provide a riding surface 176 (FIG. 6) for the sealing element 144 disposed in the sealing groove 142 of the stationary housing 102 (e.g., the shaft portion 138 thereof). As described herein, the sleeve insert 170 is mounted between the inner wall 152 of the driven hub 104 and the outer surface of the shaft portion 138 of the stationary housing 102 after the driven hub 104 is installed over the stationary housing 102 (i.e., after the shaft portion 138 of the stationary housing 102 is inserted into the opening defined by the inner wall 152 of the driven hub 104). In some examples, the sleeve insert 170 is interference-fitted (e.g., press-fitted or friction-fitted) to the inner wall 152 of the driven hub 104. In other examples, the sleeve insert 170 can be fastened to the inner wall 152 of the driven hub 104. In yet other examples, the sleeve insert 170 can be attached to the driven hub 104 with adhesive. The sealing element 144 can be an annular gasket, such as an elastomeric O-ring seal, X-ring seal, and duo cone seal.

Referring to FIG. 6, in some examples, the sleeve insert 170 includes a body portion 172 and a flange portion 174. The body portion 172 is configured as a cylindrical shape defining an opening through which the shaft portion 138 of the stationary housing 102 passes. The body portion 172 has an inner diameter D₁ that is slightly larger than an outer diameter D_{S} of the shaft portion 138 of the stationary housing 102 such that the driven hub 104 rotates around the shaft portion 138 of the stationary housing 102. A difference or gap between the inner diameter D₁ of the sleeve insert 170 and the outer diameter D_{S} of the shaft portion 138 ranges between 1/500 and 1/7000 inches. In some examples, the gap is about 1/1000 inches. In other examples, the gap is about 1/5000 inches. Other gaps can be used as well depending on different applications.

The flange portion 174 of the sleeve insert 170 radially outwardly extends from the body portion 172 of the sleeve insert 170. In some examples, as shown in FIGS. 4 and 5, the flange portion 174 projects from the body portion 172 at one axial end of the body portion 172 such that the body portion 172 and the flange portion 174 form an L-shape. In other examples, the flange portion 174 radially extends from the body portion 172 between the opposite axial ends of the body portion 172. The flange portion 174 is dimensioned to seat against the recess 160 when the sleeve insert 170 is fitted to the inner wall 152 at the radial end 158. In some examples, the flange portion 174 may be shaped to correspond to the recess 160 of the inner wall 152. As the sleeve insert 170 is inserted and fitted to the radial end 158 of the inner wall 152, the flange portion 174 engages the recess 160 of the inner wall 152 so as to limit the insertion of the sleeve insert 170 and arrange the sleeve insert 170 in place with respect to the inner wall 152.

In some examples, a sealing element 178 (e.g., an annular seal having an elastomeric character, such as an O-ring, X-ring, duo cone ring, or other seals) can be provided between the sleeve insert 170 and the inner wall 152 of the driven hub 104. For example, the sealing element 178 can be arranged at the corner formed by the body portion 172 and the flange portion 174 and disposed between the sleeve insert 170 and the radial end 158 of the inner wall 152 when the sleeve insert 170 is fitted into the inner wall 152.

The body portion 172 of the sleeve insert 170 can provide a seal riding surface 176 defined by an inner radial surface of the body portion 172. The seal riding surface 176 faces radially inwardly toward the axis of rotation A. The seal riding surface 176 provides a surface on which the sealing element 144 disposed in the sealing groove 142 of the shaft portion 138 of the stationary housing 102 slides as the driven hub 104 rotates relative to the stationary housing 102. Accordingly, the body portion 172 of the sleeve insert 170 is subjected to wear during operation of the hydraulic device 100.

The sleeve insert 170 can be made of wear-resistant material. For example, the sleeve insert 170 can be made of hardened steel. In some examples, the sleeve insert 170 can be made of a material different from the driven hub 104. For example, the sleeve insert 170 can allow the use of a less expensive, wear-resistant material in making the driven hub 104. Typically, the driven hub 104 is made of a single material. Without the sleeve insert 170, the inner wall 152 (e.g., the radial end 158) of the driven hub 104 can directly contact the sealing element 144 and/or the outer surface of the shaft portion 138 of the stationary housing 102. Thus, the driven hub 104 should be entirely replaced when the inner wall 152 is worn at or above a predetermined level. Alternatively, the entirety of the driven hub 104 should be made with expensive wear-resistant material to increase its product life. By making the sleeve insert 170 as a separate piece from the driven hub 104, the driven hub 104 can be made of a less wear-resistant material, thereby reducing manufacturing costs.

Further, the configuration of the driven hub 104 with the separate sleeve insert 170 can ease assembly of the driven hub 104 to the stationary housing 102. This configuration can allow for an increased clearance between the shaft portion 138 of the stationary housing 102 and the inner wall 152 of the driven hub 104 during the installation, thereby reducing assembly costs and minimizing a risk of damage to a seal surface for the sealing element 144 during the installation. Further, the sleeve insert 170 is mounted after the stationary housing 102 and the driven hub 104, which are large and ing mechanism. A sealing element is disposed between the sleeve insert and the stationary the stationary housing 102 and the driven hub 104 by inserting the sleeve insert 170 therebetween.

The hydraulic device 100 may include the bearings including a first bearing 180 and a second bearing 182 that are positioned between the stationary housing 102 and the driven hub 104 to allow the driven hub 104 to rotate relative to the stationary housing 102 about the axis of rotation A, which extends through the shaft passage 140. The axis of rotation A is defined by the bearings 180 and 182. The bearings 180 and 182 can be of a variety of type. In some examples, the bearings 180 and 182 are thrust bearings.

The first bearing 180 may be disposed adjacent the first housing end 132 between the shaft portion 138 and the inner surface of the driven hub 104. In some examples, the first bearing 180 is arranged to abut the first axial face 154 of the inner wall 152 of the driven hub 104, as illustrated in FIGS. 4 and 5. Similarly to the first bearing 180, the second bearing 182 may be disposed at the other side of the inner wall 152, opposite to the first bearing 180. In some examples, the second bearing 182 is arranged to abut the second axial face 156 of the inner wall 152 of the driven hub 104, as illustrated in FIGS. 4 and 5. The arrangement of the first and second bearings 180 and 182 on the opposite sides of the inner wall 152 can provide a balanced support for the driven hub 104 relative to the stationary housing 102 when the driven hub 104 rotates.

Although it is illustrated that two bearings are provided to the hydraulic device 100, other examples can include only one bearing, or three or more bearings, disposed between the driven hub 104 and the stationary housing 102.

In addition to the sealing element 144, the hydraulic device 100 may include other sealing arrangements. For example, the hydraulic device 100 includes an end seal arrangement 186 disposed between the stationary housing 102 and the driven hub 104. As illustrated in FIGS. 3-5, the end seal arrangement 186 includes two sealing seats (i.e., a first sealing seat 188 and a second sealing seat 190) formed on the circumference of a seal supporting ring 192. The seal supporting ring 192 is disposed between the base portion 136 (i.e., the first housing end 132) of the stationary housing 102 and the first hub end 146 of the driven hub 104 such that the first sealing seat 188 abuts the base portion 136 of the stationary housing 102 and the second sealing seat 190 abuts the first hub end 146 of the driven hub 104. The first and second sealing seats 188 and 190 receive sealing elements (e.g., O-ring seals, X-seals, and duo cone seals) thereon that provide sealing of the stationary housing 102 and the driven hub 104, respectively, against the environment of the hydraulic device 100. In addition to the end seal arrangement 186, the hydraulic device 100 can include various seal arrangements at different locations. Examples of additional seal arrangements are disclosed in U.S. Patent Application Publication Nos. 2014/0023543 and 2014/0023544, the entirety of which are incorporated herein by reference.

Referring to FIGS. 3 and 4, the coupling mechanism 106 is configured to couple the drive shaft 130 to the driven hub 104 and transfer torque from the drive shaft 130 to the driven hub 104. In some examples, the coupling mechanism 106 may include a coupler 200, a brake piston 202, a brake assembly 204, and a spring assembly 206. An example configuration of the coupling mechanism 106, including the coupler 200, the brake piston 202, the brake assembly 204, and the spring assembly 206, is disclosed in more detail in U.S. Patent Application Publication Nos. 2014/0023543 and 2014/0023544, the entirety of which are incorporated herein by reference.

The coupler 200 is configured to couple the drive shaft 130 to the driven hub 104. The coupler 200 and the driven hub 104 can rotate as a unit about the axis of rotation A when driven by the drive shaft 130. The coupler 200 may be coupled to the driven hub 104 by a plurality of fasteners 212, such as bolts and cams, that are circumferentially spaced around the axis of rotation A along a perimeter of the coupler 200. The drive shaft 130 is coupled to the coupler 200 by a splined mechanical interface (e.g., a crown spline interface). An end plug 214 mounts to the coupler 200 and encloses the end of the shaft passage 140. The end plug 214 can be threaded into the coupler 200 and can oppose an end of the drive shaft 130 in the shaft passage 140.

The brake piston 202 operates as a lock piston as is known in the art. The brake piston 202 is configured to frictionally engage with and be carried with the coupler 200 and the driven hub 104, thus rotating with the coupler 200 and the driven hub 104 as a unit when the coupler 200 and the driven hub 104 are rotated about the axis of rotation A by the drive shaft 130. The brake piston 202 is configured to actuate the brake assembly 204.

The brake assembly 204 includes a plurality of first brake pads 218 and a plurality of second brake pads 220. The first brake pads 218 are configured to be mounted to the stationary housing 102 and the second brake pads 220 are configured to be carried by the driven hub 104 such that the second brake pads 220 rotate relative to the first brake pads 218 when the driven hub 104 rotate relative to the stationary housing 102. The first and second brake pads 218 and 220 are interleaved relative to one another. When the brake assembly 204 is compressed, relative rotation is not allowed between the driven hub 104 and the stationary housing 102. A plurality of serrations 222 may be disposed at least partially on interior diameters of the first brake pads 218 and engage with corresponding serrations on the stationary housing 102 to limit relative rotation between the first brake pads 218 and the stationary housing 102. A plurality of tabs 224 may be disposed at least partially on outer diameters of the second brake pads 220 and fit within corresponding tab slots defined by the driven hub 104 to limit relative rotation between the driven hub 104 and the second brake pads 220.

The spring assembly 206 operates to actuate the brake assembly 204. In some examples, the spring assembly 206 can actuate the brake assembly 204 by applying a braking force through the brake piston 202 to the brake assembly 204 to compress the first and second brake pads 218 and 220 together such that relative rotation between the stationary housing 102 and the driven hub 104 is resisted by friction between the first and second brake pads 218 and 220. The spring assembly 206 may be located between the brake piston 202 and the coupler 200. In some example, the spring assembly 206 is compressed between the coupler 200 and the brake piston 202 such that the spring assembly 206 is preloaded with a spring force. In this configuration, the spring assembly 206 operates to normally urge the brake piston 202 against the brake assembly 204 to compress the brake assembly 204 in default.

Referring to FIG. 4, the hydraulic device 100 may include a brake chamber 230 formed on the brake assembly side of the brake piston 202 (i.e., the side opposite to the spring assembly 206). To release the brake, the brake chamber 230 may be pressurized. When the brake is released, rotation of the driven hub 104, the coupler 200, the brake piston 202, the second brake pads 220, and the spring assembly 206 is permitted relative to the stationary housing 102. In some examples, the brake chamber 230 is pressurized by placing the brake chamber 230 in fluid communication with a pilot/charge pressure of a hydraulic circuit powering the hydraulic motor 108.

The brake chamber 230 may be sealed with one or more seal arrangements including the sealing element 144, as described herein. For example, the sealing element 144 is arranged to provide a sufficient sealing capacity for the brake chamber 230. In some examples, the sealing element 144 riding on the sleeve insert 170 can be configured to withstand a pressure up to 750 psi while the end seal arrangement 186 can resist around 50 psi. The sealing element 178 can additionally be provided for sealing for the brake chamber 230, as described above.

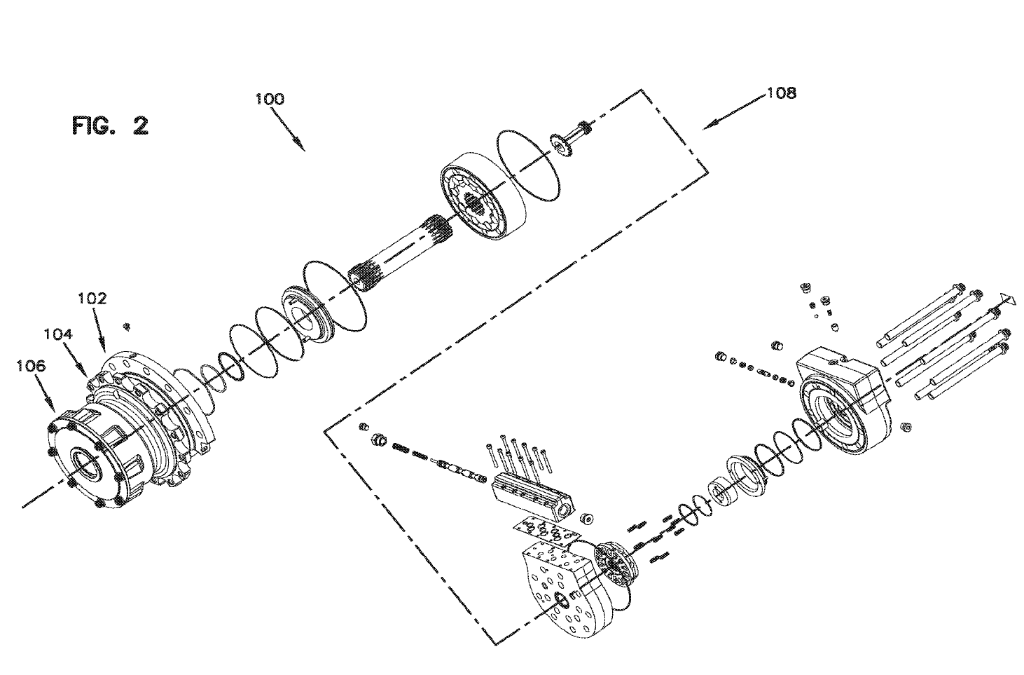

Referring to FIGS. 2 and 4, the hydraulic motor 108 is rear-piloted, and includes a motor housing assembly back-mounted to the stationary housing 102. In some examples, the hydraulic motor 108 is a gerotor-type hydraulic motor. An example of the hydraulic motor 108 is disclosed in U.S. Patent Application Publication Nos. 2014/0023543 and 2014/0023544, the entirety of which are incorporated herein by reference.

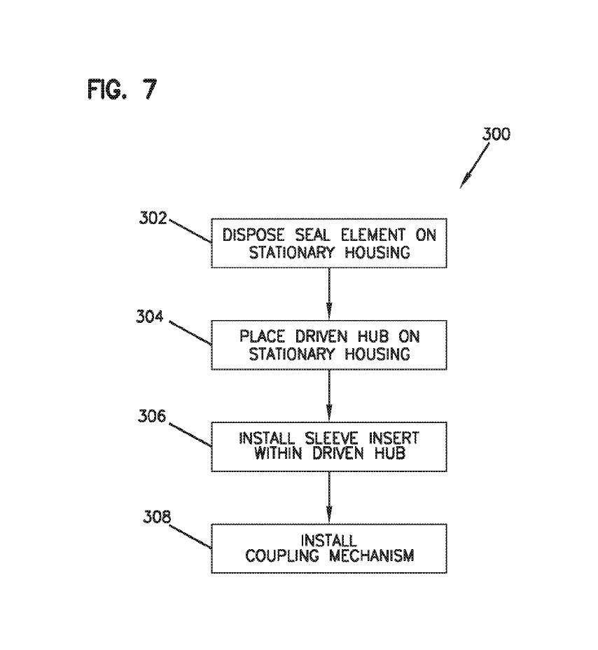

Referring to FIG. 7, an example method 300 of assembling the hydraulic device 100 is disclosed in accordance with the principles of the present disclosure. In some examples, the method 300 may generally include operations 302, 304, 306 and 308.

At the operation 302, the sealing element 144 is mounted on the stationary housing 102. For example, the sealing element 144 can be placed in the sealing groove 142 formed on the shaft portion 138 of the stationary housing 102.

At the operation 304, the driven hub 104 is installed over the stationary housing 102. For example, the driven hub 104 is placed around the shaft portion 138 of the stationary housing 102 in an assembling direction D1 (FIG. 4) such that the inner wall 152 of the driven hub 104 is arranged over the sealing element 144 disposed on the shaft portion 138 of the stationary housing 102.

At the operation 306, the sleeve insert 170 is mounted within the driven hub 104. For example, the sleeve insert 170 is engaged with the inner wall 152 of the driven hub 104 in the assembling direction D1. The sleeve insert 170 is disposed between the inner wall 152 of the driven hub 104 and the sealing element 144 disposed in the shaft portion 138 of the stationary housing 102. As described herein, the sleeve insert 170 provides the riding surface 176 for the sealing element 144 as the driven hub 104 rotates relative to the stationary housing 102. The sleeve insert 170 can be fixed to the inner wall 152 of the driven hub 104 by interference-fit.

At the operation 308, the coupling mechanism 106 is secured to the driven hub 104 and the drive shaft 130 in the assembling direction D1. The coupling mechanism 106 is installed to couple the driven hub 104 to the drive shaft 130. As described herein, the coupling mechanism 106 operates to couple the drive shaft 130 to the driven hub 104 such that torque from the drive shaft 130 is transferred to the driven hub 104 causing the driven hub 104 to rotate relative to the stationary housing 102.

In addition to the operations 302, 304, 306 and 308, the first bearing element 180 can be engaged around the shaft portion 138 of the stationary housing 102 in the assembling direction D1 before the driven hub 104 is placed around the shaft portion 138 of the stationary housing 102. In some examples, the first bearing element 180 can be arranged to abut the first axial face 154 of the inner wall 152 when the hydraulic device 100 is assembled. Further, the second bearing element 182 can be engaged around the shaft portion 138 of the stationary housing 102 in the assembling direction D1 after the driven hub 104 is placed around the shaft portion 138 of the stationary housing 102. Similarly to the first bearing element 180, the second bearing element 182 can be arranged to abut the second axial face 156 of the inner wall 152 when the hydraulic device 100 is assembled.

The various examples described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

1. A hydraulic drive comprising:
a stationary housing having a shaft portion, the shaft portion defining a shaft passage therethrough and a sealing groove radially formed thereof, the sealing groove configured to receive a sealing element;
a driven hub adapted to be connected to a rotatable driven element, the driven hub including an inner wall, the inner wall radially inwardly extending from an inner surface of the driven hub and having a first axial face, a second axial face opposite to the first axial face, and a radial end connecting the first and second axial faces, the radial end defining an opening through which the shaft portion of the stationary housing passes;
a drive shaft extending through the shaft passage of the stationary housing;
a hydraulic motor for rotating the drive shaft relative to the stationary housing;
a coupling mechanism coupling the drive shaft to the driven hub such that torque from the drive shaft is transferred to the driven hub causing the driven hub to rotate relative to the stationary housing; and
a sleeve insert disposed between the radial end of the driven hub and the sealing groove of the stationary housing, the sleeve insert providing a riding surface on which the sealing element disposed in the sealing groove of the stationary housing slides as the driven hub rotates relative to the stationary housing.

2. The hydraulic drive according to claim 1, further comprising:
a first bearing element disposed between the shaft portion of the stationary housing and the inner surface of the driven hub to rotate relative to the stationary housing about an axis of rotation that extends through the shaft passage, the first bearing element arranged to abut the first axial face of the inner wall of the driven hub.

3. The hydraulic drive according to claim 1, further comprising:
a second bearing element disposed between the shaft portion of the stationary housing and the inner surface of the driven hub to enable the driven hub to rotate relative to the stationary housing about an axis of rotation that extends through the shaft passage, the second bearing element arranged to abut the second axial face of the inner wall of the driven hub.

4. The hydraulic drive according to claim 1, further comprising:
a second sealing element disposed between the sleeve insert and the radial end of the inner wall.

5. The hydraulic drive according to claim 1, wherein the second axial face of the inner wall faces the coupling mechanism.

6. The hydraulic drive according to claim 1, wherein the sleeve insert is interference-fit to the inner wall of the driven hub.

7. The hydraulic drive according to claim 1, wherein the sleeve insert is made of hardened steel.

8. The hydraulic drive according to claim 1, wherein the hydraulic motor is a gerotor-type hydraulic motor.

9. The hydraulic drive according to claim 1, wherein the coupling mechanism comprises:
a coupler for coupling the drive shaft to the driven hub; and
a brake piston mounted between the driven hub and the coupler and frictionally engaged with the driven hub and the coupler such that the coupler, the driven hub, and the brake piston are configured to rotate as a unit when driven by the drive shaft.

10. The hydraulic drive according to claim 9, wherein the brake piston is configured to actuate a brake assembly having first brake pads mounted to the stationary housing and second brake pads carried by the driven hub such that the second brake pads rotate relative to the first brake pads when the driven hub rotates relative to the stationary housing, the first and second brake pads being interleaved relative to one another.

11. The hydraulic drive according to claim 10, further comprising a spring assembly for actuating the brake assembly by applying a braking force through the brake piston to the brake assembly to compress the first and second brake pads together such that relative rotation between the stationary housing and the driven hub is resisted by friction between the first and second brake pads.

12. A method of manufacturing a hydraulic drive, the method comprising:
disposing a seal element in a seal groove formed on a shaft portion of a stationary housing, the shaft portion defining a shaft passage through which a drive shaft extends;
placing a driven hub around the shaft portion of the stationary housing such that an inner wall of the driven hub is arranged over the seal element disposed on the shaft portion of the stationary housing, the inner wall radially extending from an inner surface of the driven hub and defining an opening through which the shaft portion of the stationary housing passes;
engaging a sleeve insert with the inner wall of the driven hub such that the sleeve insert is disposed between the inner wall of the driven hub and the seal element disposed in the shaft portion of the stationary housing, the sleeve insert providing a riding surface on which the seal element slides as the driven hub rotates relative to the stationary housing; and
engaging a coupling mechanism to the driven hub and the drive shaft, the coupling mechanism configured to couple the drive shaft to the driven hub such that torque from the drive shaft is transferred to the driven hub causing the driven hub to rotate relative to the stationary housing.

13. The method according to claim 12, wherein engaging a sleeve insert with the inner wall of the driven hub includes fixing the sleeve insert with the inner wall of the driven hub by interference-fit.

14. The method according to claim 12, further comprising:
engaging a first bearing element around the shaft portion of the stationary housing before placing the driven hub around the shaft portion of the stationary housing, the first bearing element arranged to abut a first axial face of the inner wall when the hydraulic drive is assembled.

15. The method according to claim 14, further comprising:
engaging a second bearing element around the shaft portion of the stationary housing after placing the driven hub around the shaft portion of the stationary housing, the second bearing element arranged to abut a second axial face of the inner wall when the hydraulic drive is assembled, the second axial face opposite to the first axial face.

16. A hydraulic drive comprising:
a stationary housing defining a shaft passage;
a driven hub adapted to be connected to a rotatable driven element;
a drive shaft extending through the shaft passage of the stationary housing;
a hydraulic motor for rotating the drive shaft relative to the stationary housing;
a coupling mechanism coupling the drive shaft to the driven hub such that torque from the shaft is transferred to the driven hub causing the driven hub to rotate relative to the stationary housing;
a sealing element disposed between the sleeve insert and the stationary housing; and
a sleeve insert fixed to the driven hub and disposed between the stationary housing and the driven hub to provide a riding surface on which the sealing element slides as the driven hub rotates relative to the stationary housing.

17. The hydraulic drive according to claim 16, wherein the sleeve insert is interference-fit to the driven hub.

18. The hydraulic drive according to claim 16, wherein the seal is an O-ring.

19. The hydraulic drive according to claim 16, wherein the sleeve insert is made of hardened steel.

20. The hydraulic drive according to claim 16,
wherein the driven hub includes an inner wall radially inwardly extending from an inner surface of the driven hub, the inner wall defining an opening configured to receive a portion of the stationary housing,
wherein the stationary housing defines a sealing groove configured to receive the sealing element, and
wherein the sleeve insert is fixed to the inner wall of the driven hub.

21. The hydraulic drive according to claim 20,
wherein the inner wall defines a first axial wall and a second axial wall opposite to the first axial wall, and
wherein a bearing element is positioned between the stationary housing and the driven hub adjacent at least one of the first and second axis walls, the bearing element enabling the driven hub to rotate relative to the stationary housing about an axis of rotation that extends through the shaft passage.

22. The hydraulic drive according to claim 16, wherein the coupling mechanism comprises:
a coupler for coupling the drive shaft to the driven hub; and
a brake piston mounted between the driven hub and the coupler and frictionally engaged with the driven hub and the coupler such that the coupler, the driven hub, and the brake piston are configured to rotate as a unit when driven by the drive shaft.

23. The hydraulic drive according to claim 22, wherein the brake piston is configured to actuate a brake assembly having first brake pads mounted to the stationary housing and second brake pads carried by the driven hub such that the second brake pads rotate relative to the first brake pads when the driven hub rotates relative to the stationary housing, the first and second brake pads being interleaved relative to one another.

24. The hydraulic drive according to claim 23, further comprising a spring assembly for actuating the brake assembly by applying a braking force through the brake piston to the brake assembly to compress the first and second brake pads together such that relative rotation between the stationary housing and the driven hub is resisted by friction between the first and second brake pads.

25. The hydraulic drive according to claim 16, wherein the hydraulic motor is a gerotor-type hydraulic motor.
